(19) United States
(12) Patent Application Publication
(10) Pub. No.: US 2026/0107149 A1
(43) Pub. Date: Apr. 16, 2026

(54) Bluetooth processing circuit and method for secure channel sounding procedure management in wireless communication systems

(71) Applicant: MEDIATEK INC., Hsinchu City (TW)

(72) Inventors: Tao-Chun Lee, Hsinchu City (TW); Tsung-Hsi Chuang, Hsinchu City (TW); Sz-Ting Shen, Hsinchu City (TW)

(73) Assignee: MEDIATEK INC., Hsinchu City (TW)

(21) Appl. No.: 19/237,009

(22) Filed: Jun. 13, 2025

Related U.S. Application Data
(60) Provisional application No. 63/706,793, filed on Oct. 14, 2024.

(51) Int. Cl. H04W 12/50; H04L 25/02; H04W 76/15

(52) U.S. Cl. CPC H04W 12/50; H04L 25/0224; H04W 76/15

(57) ABSTRACT

A Bluetooth processing circuit and a method for managing channel sounding (CS) security procedures are disclosed. A controller layer of the Bluetooth processing circuit receives a first CS security enable command from a host layer to initiate a first CS security start procedure with a peer Bluetooth device. After receiving the first CS security enable command, if the controller layer receives a second CS security enable command from the host layer while the first CS security start procedure remains in progress, the controller layer rejects the second CS security enable command. The controller layer then sends an error status event to the host layer to signal the rejection, thereby preventing interference with the ongoing CS security start procedure.

### CROSS REFERENCE TO RELATED APPLICATIONS

This application claims the benefit of U.S. Provisional Application No. 63/706,793, filed on Oct. 14, 2024. The content of the application is incorporated herein by reference.

### BACKGROUND

Bluetooth® wireless technology enables short-range communication between devices, facilitating a wide range of applications. Distance estimation features, such as channel sounding (CS) in Bluetooth® low energy (LE), allow devices to approximate the physical distance between them. These features rely on the exchange of specific radio frequency (RF) signals and often involve security procedures to protect the integrity and confidentiality of the measurements and associated communications.

Bluetooth® is a registered trademark of Bluetooth SIG, Inc., and Wi-Fi® is a registered trademark of Wi-Fi Alliance. For readability and conciseness throughout this specification, the terms “Bluetooth” and “Wi-Fi” will subsequently be used to refer to their respective technologies without repeated use of the trademark symbol®. This usage is for descriptive purposes and is not intended to challenge the validity or ownership of these trademarks.

Secure distance estimation protocols are important for applications like secure access control (e.g., digital car keys). Many such protocols rely on cryptographic primitives, including pseudorandom functions (PRFs), to establish secure communication contexts. However, existing security analyses have indicated that relying solely on the basic assumptions of PRF properties might be insufficient to prevent sophisticated certain attacks. Vulnerabilities such as distance-fraud (where a malicious device tricks a verifier into believing it is closer than it actually is) or man-in-the-middle (MiTM) attacks (where an attacker relays communications and potentially modifies them) can arise if the underlying security mechanisms, particularly those involving the setup and management of security parameters based on PRFs, are not robustly handled. Therefore, there is a need for enhanced mechanisms within Bluetooth channel sounding security procedures to mitigate these risks and ensure the integrity and robustness of distance estimation operations against potential security threats.

### SUMMARY

An embodiment of the present invention provides a Bluetooth processing circuit. The Bluetooth processing circuit comprises a first memory and a central processing circuit coupled to the first memory. The first memory is configured to store first instructions. The central processing circuit is configured to execute the first instructions stored in the first memory to perform operations of a Bluetooth controller layer. The operations of the Bluetooth controller layer comprise receiving a first channel sounding (CS) security enable command from a host layer to initiate a first CS security start procedure with a peer Bluetooth device; initiating the first CS security start procedure based on the first CS security enable command; receiving a second CS security enable command from the host layer while the first CS security start procedure is in progress; and rejecting the second CS security enable command while the first CS security start procedure remains in progress.

Another embodiment of the present invention provides a method of operating a Bluetooth processing circuit. The method comprises initiating a first channel sounding (CS) security start procedure with a peer Bluetooth device based on a first CS security enable command; and rejecting a second CS security enable command while the first CS security start procedure remains in progress.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sequence diagram illustrating a test procedure for ensuring an initial channel sounding (CS) security start procedure can be completed by rejecting a subsequent security start request while the initial CS security start procedure is in progress according to an embodiment of the present invention.

FIG. 2 is a block diagram illustrating the architecture of two interacting Bluetooth devices configured for channel sounding according to an embodiment of the present invention.

FIG. 3 is a block diagram illustrating an exemplary hardware architecture of an electronic device capable of implementing the Bluetooth functionalities according to an embodiment of the present invention.

### DETAILED DESCRIPTION

The detailed description set forth below in connection with the appended drawings is intended as a description of various configurations and is not intended to represent the only configurations in which the concepts described herein may be practiced. The detailed description includes specific details to provide a thorough understanding of the various concepts. However, it will be apparent to those skilled in the art that these concepts may be practiced without these specific details.

As discussed in the background, secure distance estimation protocols, including aspects of Bluetooth channel sounding, can face vulnerabilities. These issues may arise if their underlying security mechanisms are not managed carefully. This concern is particularly relevant for the process of establishing the required security arrangements that rely on pseudorandom functions. Such a process typically involves agreeing upon or exchanging specific security parameters and, from these parameters, deriving or generating the cryptographic keys or keying material required for secure operations. Permitting multiple, concurrent procedures aimed at establishing these security arrangements between two Bluetooth devices introduces risks. Such concurrent operations could lead to inconsistencies in the active security parameters or the derived cryptographic state within the system. They might also expose the system to attacks, such as distance-fraud or Man-in-the-Middle (MiTM) attacks. In these situations, an attacker could exploit confusion related to timing or the correct set of security parameters and derived keys. The embodiments described herein address these potential problems. They introduce a mechanism to ensure the security of the channel sounding (CS) security start procedure.

In the context of Bluetooth Core Specification 6.0 testing, especially for features related to Channel Sounding (CS), three main entities are involved. These are the upper tester, the implementation under test (IUT), and the lower tester. Each entity plays its own role in the testing process. Their roles contribute to the comprehensive evaluation of a Bluetooth device's conformance and functionality.

The upper tester typically resides within the host portion of a Bluetooth system architecture. Its primary responsibility is to initiate and control test scenarios by interacting with the IUT through a standardized interface, which is commonly the Host Controller Interface (HCI). The HCI provides a uniform method for the host to access the Bluetooth controller's capabilities. The upper tester sends commands to the IUT. In turn, it receives status events or packet reports that indicate the outcome of these commands or the IUT's operational state. When it comes to testing Channel Sounding functionalities, the upper tester's role involves initiating security-related procedures on the IUT. This includes enabling or configuring security features associated with Channel Sounding. Furthermore, the upper tester monitors the IUT's behavior and responses to these security-related commands. It looks for indications of success or failure in the activation of the Channel Sounding system. Essentially, the upper tester acts as the conductor of the test. It operates at a higher protocol level to drive the IUT's actions and observe the results of security tests.

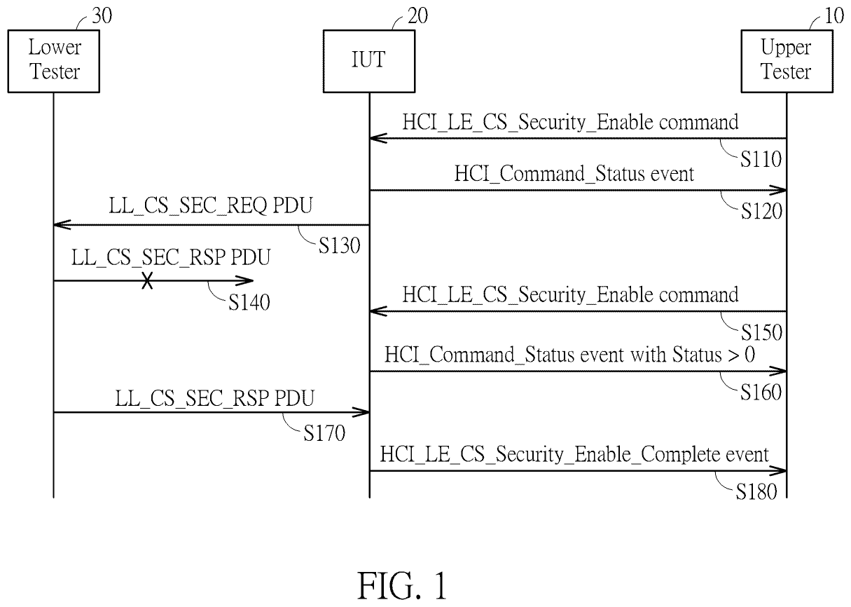

Please refer to FIG. 1. FIG. 1 is a sequence diagram illustrating a test procedure for ensuring an initial channel sounding (CS) security start procedure can be completed by rejecting a subsequent security start request while the initial CS security start procedure is in progress according to an embodiment of the present invention. The test procedure is designed to verify that an implementation under test (IUT) 20, acting as a central role, can reject a request from an upper tester 10 for another CS security start procedure while an initial CS security start procedure is already in progress. In this test scenario, the upper tester 10 typically plays the role of a host, responsible for sending high-level commands to the IUT 20, for example, by sending commands via a host controller interface (HCI). The lower tester 30, on the other hand, plays the role of a controller of a peer device, responsible for interacting with the link layer of the IUT 20, for example, by exchanging link layer control protocol data units (LL PDUs). The IUT 20 is the Bluetooth device being measured, which assumes the central role in the test procedure. The upper tester 10 and the lower tester 30 can be dedicated test equipment or standard Bluetooth devices with corresponding functionalities. The IUT 20 is a Bluetooth device that supports the channel sounding function.

The test procedure includes the following steps:

Step S110: The upper tester 10 sends an HCI_LE_CS Security Enable command (i.e., “host controller interface low energy channel sounding security enable command,” hereinafter also referred to as a “channel sounding (CS) security enable command” or simply a “CS security enable command” as recited in the claims) to the IUT 20. The HCI_LE_CS Security Enable command is used to request the IUT 20 to start or re-start a CS security start procedure.

Step S120: The IUT 20 sends a successful HCI Command Status event (i.e., host controller interface command status event) to the upper tester 10. The HCI Command Status event indicates that the IUT 20 has received the HCI_LE_CS_Security_Enable command and has started processing it. This processing is the initial CS security start procedure.

Step S130: As part of the initial CS security start procedure, the IUT 20 sends an LL CS SEC REQ PDU (link layer channel sounding security request protocol data unit) to its peer, the lower tester 30, requesting to exchange security parameters.

Step S140: The lower tester 30 intentionally delays its response and does not immediately send an LL CS SEC RSP PDU (link layer channel sounding security response protocol data unit) to the IUT 20. This delay is to simulate the state where the initial CS security start procedure has not yet completed.

Step S150: While the IUT 20 is still waiting for a response from the lower tester 30 (i.e., the initial CS security start procedure is still in progress), the upper tester 10 sends another HCI_LE_CS Security Enable command to the IUT 20, attempting to initiate another CS security start procedure.

Step S160: According to the embodiment of the present invention, the IUT 20 rejects this repeated request from the upper tester 10 (i.e., the HCI_LE_CS Security Enable command sent in step S150) and sends an HCI Command Status event to the upper tester 10, where the status field of the HCI Command Status event contains an error code greater than 0, for example, Command Disallowed (0x0C) defined in Bluetooth Core Specification 6.0, thereby constituting an “error status event” as referred to in the claims, indicating that the new request cannot be executed because the initial CS security start procedure is still in progress.

Step S170: At this point, the lower tester 30 sends an LL CS SEC RSP PDU to the IUT 20, responding to the request in step S130.

Step S180: After receiving the response from the lower tester 30, the IUT 20 completes the initial CS security start procedure and sends a successful HCI_LE_CS Security Enable Complete event (hereinafter also referred to as the “HCI Low Energy Channel Sounding Security Enable Complete event” as recited in the claims) to the upper tester 10, indicating that the initial CS security start procedure has been successfully completed.

It should be understood that once the initial CS security start procedure, initiated by the command in step S110, is successfully completed as indicated in step S180, the IUT 20 is then ready to accept and process a new HCI_LE_CS_Security_Enable command. If, for instance, the upper tester 10 were to send another HCI_LE_CS Security Enable command after the completion event of step S180, the IUT 20 would process this new command normally, sending back an HCI Command Status event indicating successful reception (Status=0), and then proceed with the new CS security start procedure, eventually sending another HCI_LE_CS_Security_Enable_Complete event upon its successful completion, assuming no other intervening errors. In other words, if the initial CS security start procedure, initiated by a first HCI_LE_CS Security Enable command, completes successfully (e.g., as indicated by the HCI_LE_CS Security Enable Complete event in step S180), the IUT 20 would then be ready to accept and process a subsequent, new HCI_LE_CS Security Enable command. This subsequent command would initiate a new CS security start procedure, which would be handled normally without rejection, as no prior CS security start procedure is pending.

The expected result of this test procedure is a pass verdict. The key to the pass verdict lies in step S160, where the IUT 20 sends an HCI Command Status event with a valid error code (Status>0) to the upper tester 10, indicating that it correctly rejected the request to start a new procedure while the initial CS security start procedure was in progress. Furthermore, the pass verdict also lies in step S180, where the IUT 20 ultimately successfully completes the initial CS security start procedure and sends a successful HCI_LE_CS Security Enable Complete event to the upper tester 10.

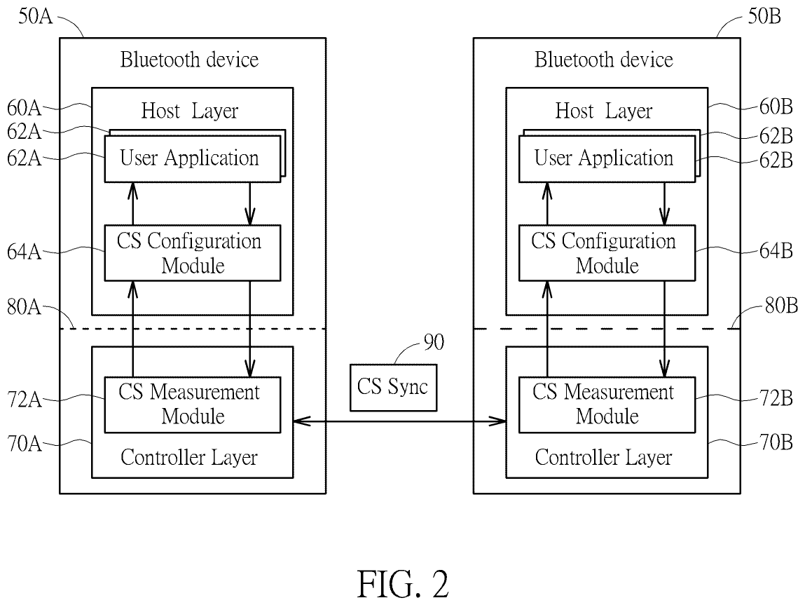

Please refer to FIG. 2. FIG. 2 is a block diagram illustrating the architecture of two interacting Bluetooth devices 50A and 50B configured for channel sounding according to an embodiment of the present invention. The Bluetooth device 50A includes a host layer 60A and a controller layer 70A communicatively coupled to the host layer 60A. The Bluetooth device 50B includes a host layer 60B and a controller layer 70B communicatively coupled to the host layer 60B. The host layer 60A communicates with the controller layer 70A via a host controller interface (HCI) 80A, and the host layer 60B communicates with the controller layer 70B via a host controller interface (HCI) 80B. The mechanisms and procedures described herein for managing CS security start procedures are applicable regardless of whether the Bluetooth device 50A and the Bluetooth device 50B are in a paired or unpaired state. These CS security management mechanisms function effectively whether Bluetooth devices 50A and 50B are in a paired state, having previously established a trusted link and exchanged security keys. These mechanisms are also fully applicable if the devices are in an unpaired state, meaning the devices themselves lack any prior security association or shared cryptographic material.

The host layer 60A includes one or more user applications 62A and a channel sounding (CS) configuration module 64A. The host layer 60B includes one or more user applications 62B and a channel sounding (CS) configuration module 64B. The user applications 62A and 62B are responsible for handling user interactions and high-level application logic, such as initiating a distance measurement function. For example, multiple user applications 62A on the Bluetooth device 50A might independently attempt to initiate channel sounding procedures with the Bluetooth device 50B. The CS configuration module 64A and the CS configuration module 64B are responsible for configuring relevant parameters for a channel sounding procedure and sending control commands to the controller layer 70A and the controller layer 70B, respectively, via the HCI 80A and the HCI 80B, respectively. For example, the CS configuration module 64A and/or the CS configuration module 64B may send an HCI_LE_CS Security Enable command to start or re-start a CS security start procedure. The functions of the host layer 60A are typically implemented by software running on a main processor of the Bluetooth device 50A, and the functions of the host layer 60B are typically implemented by software running on a main processor of the Bluetooth device 50B.

The controller layer 70A includes a CS measurement module 72A, and the controller layer 70B includes a CS measurement module 72B. The CS measurement module 72A and the CS measurement module 72B are responsible for executing actual channel sounding measurements, including handling link layer protocols related to channel sounding, such as sending and receiving an LL_CS_SEC REQ PDU and an LL CS SEC RSP PDU, and performing calculations related to a Normalized Attack Detector Metric (NADM) algorithm. The functions of the controller layer 70A and the controller layer 70B can be implemented by firmware, hardware, or a combination thereof, typically running on a Bluetooth chip or a dedicated wireless communication processor.

The controller layer 70A of the Bluetooth device 50A and the controller layer 70B of the Bluetooth device 50B synchronize with each other via a channel sounding sync (CS Sync) mechanism 90. The CS Sync 90 ensures that the two Bluetooth devices 50A and 50B have coordinated timing and frequency when executing a channel sounding procedure.

When the host layer 60A of the Bluetooth device 50A wants to start or re-start a CS security start procedure with another Bluetooth device 50B, the CS configuration module 64A in its host layer 60A sends an HCI_LE_CS Security Enable command to its local controller layer 70A via the HCI 80A. After receiving this HCI_LE_CS Security Enable command, the controller layer 70A will begin executing link layer operations related to the CS security start procedure, for example, sending an LL CS SEC REQ PDU to the controller layer 70B of the peer device (i.e., the Bluetooth device 50B).

The test procedure shown in FIG. 1 verifies a key behavior within the system architecture that is illustrated in FIG. 2. This key behavior is as follows: when an initial CS Security Start procedure is in progress, the controller layer is designed to reject a request for a new CS Security Start procedure. This request would be initiated by the host layer, which can be either a local host or a remote host. This behavior is in accordance with the rule: “While the CS security start procedure is in progress, the local Link Layer shall reject the CS security start procedure invoked from either the local or remote host until the CS security start procedure is complete.”

The CS security start procedure involves the exchange of security parameters, including a CS IV (Channel Sounding Initialization Vector), a CS IN (Channel Sounding Instantiation Nonce), and a CS PV (Channel Sounding Personalization Vector). These parameters are the basis for a pseudorandom function used in subsequent channel sounding steps. To enhance security and make Man-in-the-Middle (MiTM) attacks more difficult, it is important to refresh these three security parameters periodically or based on certain triggers, which involves initiating new CS security start procedures. However, if another CS security start procedure (possibly using different parameters or intended to refresh existing ones) is allowed to start before a preceding CS security start procedure is completed, it could lead to the pseudo-noise (PN) bit sequence corresponding to the preceding procedure being tampered with or corrupted, thereby affecting the accuracy and security of the channel sounding measurement. Therefore, rejecting any attempt to initiate a new procedure before the preceding CS security start procedure is completed is important to protect the integrity of the ongoing CS security start procedure and the correctness of its parameters, ensuring that each parameter refresh or new security context establishment completes successfully before another can begin.

The relationship between FIG. 1 and FIG. 2 is that the upper tester 10 simulates the behavior of a host layer, such as the host layer 60A or the host layer 60B. The IUT 20 represents a Bluetooth device that includes a controller layer, such as the controller layer 70A or the controller layer 70B. The HCI_LE_CS Security Enable command in step S110 and step S150 corresponds to an initiation request sent from the host layer to the controller layer. The behavior of the IUT 20 rejecting the second command in step S160 precisely embodies the protection mechanism of the controller layer.

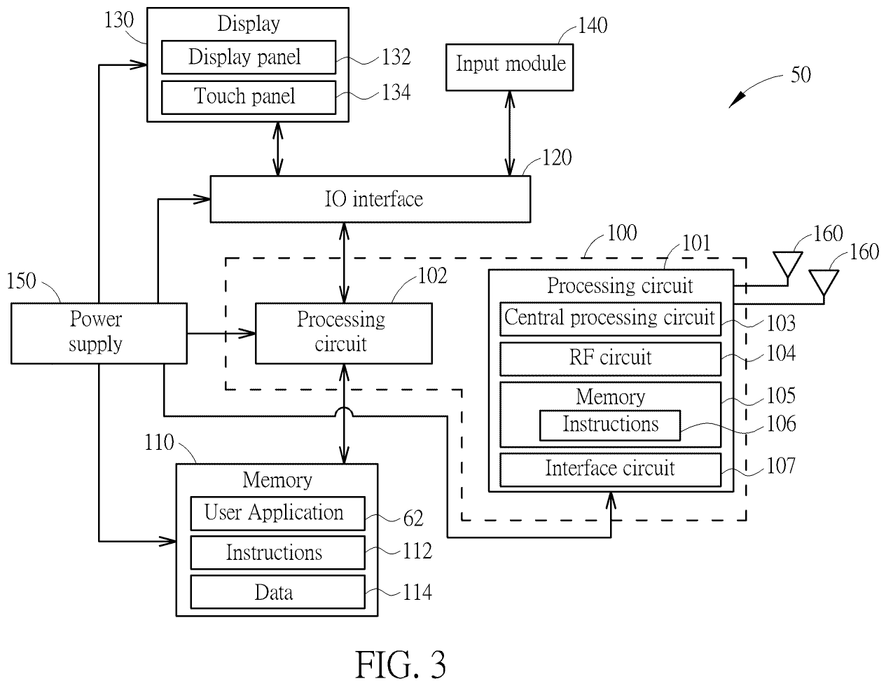

A first application scenario of the present invention involves a user manually triggering a distance measurement. Assume a user operates one of the user applications 62A located in the host layer 60A on the Bluetooth device 50A. The user clicks a button within this user application 62A to initiate a distance measurement using channel sounding. The user application 62A then, via the CS configuration module 64A, sends a first HCI_LE_CS Security Enable command to the local controller layer 70A to initiate a CS security start procedure with a peer device (e.g., the Bluetooth device 50B). After receiving the command, the controller layer 70A starts executing the initial CS security start procedure, which includes link layer interactions with the controller layer 70B of the Bluetooth device 50B, such as sending an LL CS SEC REQ PDU. Assume that while this initial CS security start procedure is not yet complete (e.g., because the Bluetooth device 50B has not responded or due to network delay), the user quickly clicks the button on the user application 62A again, intending to trigger another distance measurement. At this point, the user application 62A will again send a second HCI_LE_CS Security Enable command to the controller layer 70A. Alternatively, a different user application (e.g., another instance of user application 62 shown in FIG. 3, or a distinct user application like 62B shown in FIG. 2) running on the host layer 60A might also attempt to send an HCI_LE_CS Security Enable command to the controller layer 70A for the same peer device 50B while the first procedure is in progress. According to the mechanism of the present invention, the controller layer 70A detects that it is currently processing an initial CS security start procedure, and therefore will reject the execution of the second HCI_LE_CS Security Enable command (whether from the same user application 62A or a different one). The controller layer 70A will send back an HCI Command Status event to its upper host layer 60A (specifically, to be received by the user application 62A), with its status field indicating an error (e.g., Command Disallowed (0x0C)). This ensures that the initial CS security start procedure is not interfered with or interrupted by subsequent requests, thereby guaranteeing the integrity and accuracy of the measurement process.

A second application scenario of the present invention involves periodic distance measurement in the background. Assume a user has activated one or more user applications 62A located in the host layer 60A on the Bluetooth device 50A. This user application 62A periodically performs channel sounding distance measurements in the background and reports the results to the user. To perform periodic measurements, the user application 62A will periodically (e.g., at regular intervals, meaning a first time interval between sending a first command and a second command can be equal to a second time interval between sending the second command and a subsequent, third command) send an HCI_LE_CS Security Enable command to the local controller layer 70A via the CS configuration module 64A, to start or re-start a CS security start procedure with the Bluetooth device 50B. Assume that at a certain point in time, the controller layer 70A is processing an initial CS security start procedure triggered by a previous periodic command, and this initial CS security start procedure is not yet complete. At this time, if the user application 62A, according to its periodic schedule, sends the next HCI_LE_CS_Security_Enable command, then according to the mechanism of the present invention, the controller layer 70A will reject this new command request. The reason for rejection is that the controller layer 70A detects that a CS security start procedure is already in progress. The controller layer 70A will send back an HCI Command Status event with an error status (Status>0) to its upper host layer 60A. This mechanism ensures that even in scenarios with periodic triggers, the controller layer 70A processes only one CS security start procedure at a time, avoiding parameter confusion or procedural state errors that could result from command stacking. This helps maintain the stability and reliability of background measurement tasks.

A third application scenario illustrates the behavior once a CS security start procedure has concluded. It should be understood that after the initial CS security start procedure, initiated by the command like that in step S110, is successfully completed, for instance as indicated by the event in step S180, the IUT 20 or controller layer 70A is then ready to accept and process a new HCI_LE_CS Security Enable command. If the upper tester 10 or host layer 60A were to send another such command following the successful completion indicated by the HCI_LE_CS Security Enable Complete event of step S180, the controller layer 70A would process this new command normally. This normal processing would involve sending back an HCI Command Status event indicating successful reception, for example with a Status field of zero, and then proceeding with the new CS security start procedure. Assuming no other intervening errors, this new procedure would eventually also complete successfully, leading to another HCI_LE_CS Security Enable Complete event. In essence, once a prior CS security start procedure is no longer pending, a subsequent HCI_LE_CS Security Enable command will trigger a new CS security start procedure that is handled without rejection.

Please refer to FIG. 3. FIG. 3 is a block diagram illustrating an exemplary hardware architecture of a Bluetooth device 50 capable of implementing the Bluetooth functionalities according to an embodiment of the present invention. The electronic device can be the Bluetooth device 50A or 50B shown in FIG. 2 and includes a processing circuit 100, a memory 110, an input/output (IO) interface 120, a display 130, an input module 140, a power supply 150, and one or more antennas 160.

The processing circuit 100 is the core of the Bluetooth device 50, responsible for executing instructions and processing data. The processing circuit 100 is designed to handle both host and controller functions for the Bluetooth device 50. In typical implementations, this involves a first processing circuit 101 dedicated to controller layer operations and a second processing circuit 102 dedicated to host layer operations, as FIG. 3 illustrates. The first processing circuit 101 is responsible for implementing controller layer functions (such as those of controller layer 70A or 70B shown in FIG. 2). The first processing circuit 101 may be implemented as a microcontroller (MCU) or as a dedicated Bluetooth communication chip, which can be a separate physical component from the second processing circuit 102. In other words, the first processing circuit 101 and the second processing circuit 102 may be implemented as distinct physical chips. In such case, the central processing circuit 103 is comprised in a first physical chip, and the second processing circuit 102 is comprised in a second physical chip different from the first physical chip. Alternatively, the first processing circuit 101 and the second processing circuit 102 can be integrated, for example, as different cores within a single System-on-Chip (SoC). In other embodiments, the second processing circuit 102 and the first processing circuit 101, along with other functionalities like Wi-Fi (e.g., Wi-Fi 7), can be integrated into a single, comprehensive SoC. In this scenario, the HCI between the host and controller portions would most likely be an internal bus or shared memory interface within the SoC. As used in this specification and the appended claims, the term “Bluetooth processing circuit” may refer to the overall processing circuit 100, the first processing circuit 101 (particularly when performing the operations of the controller layer), the second processing circuit 102 (particularly when performing the operations of the host layer described in some embodiments), or a combination thereof that performs the described functionalities for secure channel sounding procedure management.

Regardless of the specific implementation form of the first processing circuit 101, first processing circuit 101 comprises several key components to perform the operations of a Bluetooth controller layer. These components include a memory 105 and a central processing circuit 103. The memory 105 is configured to store instructions 106, which may be implemented as firmware for the first processing circuit 101. The central processing circuit 103 is coupled to the memory 105 and configured to execute the instructions 106, thereby performing the operations of the controller layer of the Bluetooth device 50 (such as the controller layer 60A or 60B shown in FIG. 2). The central processing circuit 103, by executing the instructions 106 from memory 105, serves as the core of the first processing circuit 101. The responsibilities of the central processing circuit 103 include managing the lower layers of the Bluetooth protocol stack, encompassing Link Layer operations like connection management, packet transmission/reception, and timing control. Particularly for the present invention, the central processing circuit 103 manages the CS security start procedure. This involves determining whether to execute a new security start request based on the status of any ongoing procedure.

The first processing circuit 101 may further comprise a radio frequency (RF) circuit 104 and an interface circuit 107. The interface circuit 107 provides a communication pathway, such as a Host Controller Interface (HCI), between the first processing circuit 101 (controller layer) and the second processing circuit 102 (host layer). The host layer sends commands to the controller layer via the interface circuit 107, and the controller layer sends events and data back to the host layer via the interface circuit 107.

The central processing circuit 103 also controls the RF circuit 104 for signal transmission and reception. The RF circuit 104 is responsible for the transmission and reception of RF signals via the one or more antennas 160. This includes modulating digital baseband signals for transmission, amplifying them, and converting received RF through signals amplification, filtering, down-conversion, and demodulation back into digital baseband signals for processing by the central processing circuit 103.

The second processing circuit 102 often serves as a main application processor of the Bluetooth device 50. The second processing circuit 102 can be a central processing unit (CPU), a core within a more complex system-on-chip (SoC), or a similar processing unit. To implement the host layer functions (such as host layer 60A or 60B shown in FIG. 2), the second processing circuit 102 executes general instructions 112 and the specific instructions of one or more user applications 62, both of which are stored in the memory 110. The second processing circuit 102 executes the instructions 112 stored in the memory 110 to perform operations of the host layer (such as the host layer 60A or 60B shown in FIG. 2). The second processing circuit 102 is primarily responsible for running an operating system, executing the upper layers of the Bluetooth protocol stack (e.g., L2CAP, SDP, various profiles), handling application logic, generating commands for the controller layer, processing events from the controller layer, and managing user interface interactions via the IO interface 120.

The memory 110 is coupled to the second processing circuit 102 of the processing circuit 100 and is used to store program code and data for the host layer of the Bluetooth device 50. As shown in FIG. 3, the memory 110 stores the one or more user applications 62, the instructions 112, and data 114. The user applications 62 represent specific application-level logic, for example, an application that initiates distance measurements. The instructions 112 may include program code for an operating system, host-level Bluetooth stack components, and other system software executed by the second processing circuit 102. The data 114 may include various data required at runtime by the operating system, the host stack, or the user applications 62, such as configuration parameters, security keys, and the like. The memory 110 can be a combination of volatile memory (e.g., RAM) and non-volatile memory (e.g., flash memory, ROM, or EEPROM).

The input/output (IO) interface 120 is responsible for communication between the second processing circuit 102 and other peripheral devices. For example, the IO interface 120 is connected to the display 130 (which may include a display panel 132 and a touch panel 134) and the input module 140 (e.g., keys, a microphone, etc.). The IO interface 120 may also include communication ports such as Universal Asynchronous Receiver/Transmitter (UART), Universal Serial Bus (USB), or Secure Digital Input/Output (SDIO)).

The power supply 150 provides the required power to all components of the Bluetooth device 50. The antennas 160 are coupled to the RF circuit 104 of the first processing circuit 101 for transmitting and receiving Bluetooth wireless signals.

The various logical components in FIG. 2 can be implemented using the hardware architecture shown in FIG. 3. The functions of the host layers 60A and 60B, including the one or more user applications 62A and 62B (referred to generically as user application 62 in FIG. 3) and the CS configuration modules 64A and 64B, are typically implemented by the second processing circuit 102 executing the software instructions 112 and the user application 62, which are stored in the memory 110. The functions of the controller layers 70A and 70B, including the CS measurement modules 72A and 72B, are implemented by the first processing circuit 101. This involves the central processing circuit 103 executing the instructions 106 stored in the memory 105, and utilizing the RF circuit 104 and the interface circuit 107. The implementation can also involve dedicated hardware logic integrated within the first processing circuit 101. The HCI 80A and the HCI 80B are logical or physical interfaces, that can be facilitated by the interface circuit 107. The RF signal exchange for channel sounding is performed by the RF circuit 104 via the antennas 160.

Using the hardware architecture shown in FIG. 3, the protection mechanisms in the aforementioned first application scenario, the aforementioned second application scenario, and the aforementioned third application scenario can be implemented.

In the first application scenario where a user manually triggers multiple times, the user operates via the input module 140 or the touch panel 134 of the display 130. The second processing circuit 102 of the processing circuit 100 executes instructions of a user application 62 stored in the memory 110, responds to the user's first trigger, and generates a first HCI_LE_CS Security Enable command. The user application 62, as shown in FIG. 3, which for example, could be user application 62A or 62B as shown in FIG. 2. The first HCI_LE_CS Security Enable command is sent from the second processing circuit 102 (host layer) via the HCI, facilitated by the interface circuit 107, to the first processing circuit 101 that executes controller layer functions. The first processing circuit 101 starts executing the initial CS security start procedure. The status of the initial CS security start procedure (e.g., “procedure in progress”) may be recorded in the memory 105 or in registers within the central processing circuit 103. When the user performs a second trigger from the same or a different user application 62 (e.g., a second user application, different from the one that made the first trigger), the second processing circuit 102 again executes the relevant instructions, generating a second HCI_LE_CS Security Enable command. When this second HCI_LE_CS Security Enable command reaches the first processing circuit 101, the logic executed by the central processing circuit 103 (based on instructions 106) checks the current status. If the central processing circuit 103 discovers that the initial CS security start procedure is still in progress, the central processing circuit 103 rejects the second HCI_LE_CS Security Enable command and sends back an HCI Command Status event with an error code to the second processing circuit 102 (host layer) via the interface circuit 107 (HCI).

In the second application scenario involving a background periodic trigger, the user application 62 executed by the second processing circuit 102, possibly using an internal timer, periodically generates an HCI_LE_CS Security Enable command and sends it to the first processing circuit 101 (controller layer). Similar to the first application scenario, if the first processing circuit 101, upon receiving a new periodic command, has its internal state indicating that a previous CS security start procedure is not yet complete, then the central processing circuit 103 will reject the new HCI_LE_CS Security Enable command and report an error status back to the second processing circuit 102 (host layer).

The hardware architecture of FIG. 3 also supports the third application scenario, where a new CS security start procedure is handled normally after a previous one has successfully completed. Assume an initial CS security start procedure, managed by the first processing circuit 101 layer), (controller has completed. Subsequently, the second processing circuit 102 (host layer) generates and transmits a new HCI_LE_CS Security Enable command via the interface circuit 107 (HCI) to the first processing circuit 101. Upon receiving the new command, the central processing circuit 103 within the first processing circuit 101 will check the status of any CS security start procedures. Finding no CS security start procedure currently in progress because the previous one has finished, the central processing circuit 103 will accept the new HCI_LE_CS Security Enable command. The central processing circuit 103 will then send an HCI Command Status event, for example, with a status of zero indicating successful reception, back to the second processing circuit 102 via the interface circuit 107. Following this, the central processing circuit 103 will initiate a new CS security start procedure based on this new command, involving necessary link layer communications with a peer device via the RF circuit 104. This new procedure will be executed normally until its completion, at which point an HCI_LE_CS Security Enable Complete event will be sent to the second processing circuit 102. Thus, the hardware architecture shown in FIG. 3 facilitates the seamless initiation and execution of a new CS security start procedure once a prior CS security start procedure is no longer in progress.

In summary, the controller layer of the present invention, for instance as implemented by the first processing circuit 101, effectively manages channel sounding (CS) security start procedures. This management approach is effective for procedures triggered by various sources, such as multiple command requests from a user rapidly repeating an operation, or commands initiated periodically by background applications. The controller layer accurately assesses the current state of any ongoing CS security start procedure. Based on this assessment, the controller layer decides how to handle a new request for another CS security start procedure. If a CS security start procedure is in progress, the new request is rejected to protect the integrity of the ongoing operation. Conversely, once a prior CS security start procedure has successfully completed, a new request is accepted, and a new CS security start procedure is initiated. This intelligent management, which relies on the current operational state, prevents potential errors by avoiding issues such as unintentional modification of security parameters or inconsistent cryptographic states that could occur if multiple security start operations were to execute concurrently. This approach significantly enhances the reliability of distance measurements and also further improves system's security. The disclosed management mechanism ensures that the key security parameters for channel sounding, such as CS_IV, CS_IN, and CS_PV, are correctly established and maintained at any given time. This is achieved by using a single CS security start procedure that completes without interference from other concurrent operations. Consequently, this mechanism helps to defend against security threats like distance-fraud or man-in-the-middle attacks. The overall security of channel sounding across different application scenarios is thereby enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A Bluetooth processing circuit, comprising:
a first memory, configured to store first instructions; and
a central processing circuit, coupled to the first memory and configured to execute the first instructions stored in the first memory to perform operations of a Bluetooth controller layer;
wherein the operations comprise:
receiving a first channel sounding (CS) security enable command from a host layer to initiate a first CS security start procedure with a peer Bluetooth device;
initiating the first CS security start procedure based on the first CS security enable command;
receiving a second CS security enable command from the host layer while the first CS security start procedure is in progress; and
rejecting the second CS security enable command while the first CS security start procedure remains in progress.

2. The Bluetooth processing circuit of claim 1 further comprises:
an interface circuit, coupled to the central processing circuit, wherein the interface circuit is configured to:
receive the first CS security enable command and the second CS security enable command from the host layer; and
forward the first CS security enable command and the second CS security enable command to the central processing circuit.

3. The Bluetooth processing circuit of claim 2, wherein the interface circuit is a host controller interface (HCI).

4. The Bluetooth processing circuit of claim 1, wherein the operations further comprise:
sending an error status event to the host layer while the first CS security start procedure remains in progress.

5. The Bluetooth processing circuit of claim 1 further comprises:
a radio frequency (RF) circuit, coupled to the central processing circuit;
wherein the operation of initiating the first CS security start procedure comprises:
the central processing circuit controlling the RF circuit to transmit a link layer CS security request protocol data unit (LL_CS_SEC_REQ PDU) to the peer Bluetooth device over a wireless radio frequency channel.

6. The Bluetooth processing circuit of claim 5, wherein the radio frequency (RF) circuit is coupled to at least one antenna, and the RF circuit is configured to transmit the LL_CS SEC REQ PDU and receive radio frequency signals via the at least one antenna.

7. The Bluetooth processing circuit of claim 5, wherein the operations of the Bluetooth controller layer further comprise:
after transmitting the LL_CS_SEC REQ PDU and after rejecting the second CS security enable command, receiving, via the RF circuit, a link layer CS security response protocol data unit (LL_CS_SEC_RSP PDU) from the peer Bluetooth device.

8. The Bluetooth processing circuit of claim 7, wherein the operations of the Bluetooth controller layer further comprise:
after receiving the LL_CS_SEC RSP PDU from the peer Bluetooth device, completing the first CS security start procedure; and
sending, to the host layer via an interface circuit, an HCI Low Energy Channel Sounding Security Enable Complete event indicating successful completion of the first CS security start procedure.

9. The Bluetooth processing circuit of claim 1 further comprises:
a processing circuit, coupled to a second memory, and configured to execute second instructions stored in the second memory to perform operations of the host layer;
wherein the operations of the host layer performed by the processing circuit executing the second instructions comprise:
generating the first CS security enable command and the second CS security enable command; and
transmitting the first CS security enable command and the second CS security enable command to the Bluetooth controller layer.

10. The Bluetooth processing circuit of claim 9, wherein the second instructions comprise instructions for a first user application and a second user application;
wherein generating the first CS security enable command is performed by the processing circuit executing the instructions for the first user application; and
wherein generating the second CS security enable command is performed by the processing circuit executing the instructions for the second user application.

11. The Bluetooth processing circuit of claim 9, wherein the operations of the host layer performed by the processing circuit executing the second instructions further comprise:
generating a third CS security enable command after generating the second CS security enable command; and
transmitting the third CS security enable command to the Bluetooth controller layer;
wherein a first time interval between a time of generating the first CS security enable command and a time of generating the second CS security enable command is equal to a second time interval between the time of generating the second CS security enable command and a time of generating the third CS security enable command.

12. The Bluetooth processing circuit of claim 9, wherein the central processing circuit and the processing circuit are embedded in a single System-on-Chip (SoC).

13. The Bluetooth processing circuit of claim 9, wherein the central processing circuit is comprised in a first physical chip, and the processing circuit is comprised in a second physical chip different from the first physical chip.

14. A method of operating a Bluetooth processing circuit, the method comprising:
initiating a first channel sounding (CS) security start procedure with a peer Bluetooth device based on a first CS security enable command; and
rejecting a second CS security enable command while the first CS security start procedure remains in progress.

15. The method of claim 14, further comprising:
sending an error status event, to a host layer, while the first CS security start procedure remains in progress.

16. The method of claim 15, wherein sending the error status event to the host layer is performed via a host controller interface (HCI).

17. The method of claim 14, wherein initiating the first CS security start procedure with the peer Bluetooth device based on the first CS security enable command comprises:
transmitting a link layer CS security request protocol data unit (LL_CS_SEC_REQ PDU) to the peer Bluetooth device over a wireless radio frequency channel.

18. The method of claim 17, further comprising:
after transmitting the LL_CS_SEC REQ PDU and after rejecting the second CS security enable command, receiving a link layer CS security response protocol data unit (LL_CS_SEC_RSP PDU) from the peer Bluetooth device.

19. The method of claim 18, further comprising:
after receiving the LL_CS_SEC_RSP PDU from the peer Bluetooth device, completing the first CS security start procedure; and
sending, to a host layer, an HCI Low Energy Channel Sounding Security Enable Complete event indicating successful completion of the first CS security start procedure.

20. The method of claim 14, further comprising:
generating the first CS security enable command on which the first CS security start procedure is based; and
generating the second CS security enable command that is rejected.
